(19) United States
(12) Patent Application Publication
(10) Pub. No.: US 2010/0289431 A1
(43) Pub. Date: Nov. 18, 2010

(54) Dimming Control Method for Display

(75) Inventors: Dong Sel Kim, Gimi-si (KR); Chang Tae Kim, Gumi-si (KR)

Correspondence Address: HARNESS, DICKEY, & PIERCE, P.L.C, 7700 Bonhomme, Suite 400, ST. LOUIS, MO, 63105, US

(73) Assignee: EPIVALLEY CO., LTD., Gumi-city (KR)

(21) Appl. No.: 12/848,590

(22) Filed: Aug. 2, 2010

Related U.S. Application Data
(63) Continuation of application No. PCT/KR2010/002417, filed on Apr. 2, 2010.

(30) Foreign Application Priority Data
Apr. 22, 2009 (KR) 10-2009-0034854

(51) Int. Cl. H05B 37/02

(52) U.S. Cl. 315/307

(57) ABSTRACT

The present disclosure provides a dimming control method for a display having a light-emitting device which includes: a first light-emitting body including an active layer generating a first light by recombination of electrons and holes; and a second light-emitting body excited by the first light and emitting a second light having a longer wavelength than the first light, the dimming control method including: controlling the power which will be supplied to the light-emitting device according to a dimming request; and adjusting the brightness of the display according to the controlled power using the second light-emitting body containing a first fluorescent material having a characteristic that chromaticity coordinates are shifted in a first direction according to the power control and a second fluorescent material having a characteristic that chromaticity coordinates are shifted in a second direction opposite to the first direction according to the power control.

### CROSS REFERENCE

This application is a continuation of PCT Application No. PCT/KR2010/002417 filed on Apr. 2, 2010, which claims the benefit and priority to Korean Patent Application No. 10-2009-0034854 filed on 22 Apr. 2009. The entire disclosures of the applications identified in this paragraph are incorporated herein by reference.

### BACKGROUND OF INVENTION

The present disclosure relates to a dimming control method for a display, and, more particularly, to a method for controlling dimming of a display (e.g., a liquid crystal display), considering the characteristics of the fluorescent materials provided in a light-emitting device used as a backlight of the display.

Herein, the light-emitting device refers to a semiconductor light-emitting device which generates light by recombination of electrons and holes, for example a III-nitride semiconductor light-emitting device. The III-nitride semiconductor light-emitting device is made of a compound containing Al₍ₓ₎Ga_{(y)}In_{(1-x-y)}N_{(0≦x≦1,0≦y≦1,0≦x+y≦1)}.

This section provides background information related to the present disclosure which is not necessarily prior art.

According to recent trends of displays, such as slim size and high performance, a liquid crystal display (LCD) has been widely used in televisions (TVs), monitors, laptops, etc. A liquid crystal panel used in the LCD cannot emit light by itself, and thus needs a separate light unit, i.e., a backlight unit (BLU). Although a cold cathode fluorescent lamp (CCFL) has been employed as a light source for the BLU, it has a slow response rate and difficulty in partial driving. Therefore, a light-emitting diode (LED) has been suggested as a light source of the BLU.

FIG. 1 is a view of an example of a conventional III-nitride semiconductor light-emitting chip. The III-nitride semiconductor light-emitting chip includes a substrate 100, a buffer layer 200 grown on the substrate 100, an n-type III-nitride semiconductor layer 300 grown on the buffer layer 200, an active layer 400 grown on the n-type III-nitride semiconductor layer 300, a p-type III-nitride semiconductor layer 500 grown on the active layer 400, a p-side electrode 600 formed on the p-type III-nitride semiconductor layer 500, a p-side bonding pad 700 formed on the p-side electrode 600, an n-side electrode 800 formed on the n-type III-nitride semiconductor layer 300 exposed by mesa-etching the p-type III-nitride semiconductor layer 500 and the active layer 400, and a protection film 900.

FIG. 2 is a view of an example of a semiconductor light-emitting device described in Korean Patent 10-0818518. The light-emitting device includes a heat sink 111, a chip 211 mounted on the heat sink 111, a first lead frame 311 coupled to the heat sink 111 to be electrically connected to the chip 211, a second lead frame 511 electrically connected to the chip 211 through a bonding wire 411, a molded frame 611 fixing the heat sink 111, the first lead frame 311, and the second lead frame 511, and forming the body of the light-emitting device, a phosphor layer 711 coated only on the periphery of the chip 211, a light-transmitting sealing material 811 covering the phosphor layer 711, and a lens 911 mounted on the light-transmitting sealing material 811, wherein the light emitted from the chip 211 becomes white light when passed through the phosphor layer 711. The chip 211 may be the III-nitride semiconductor light-emitting chip described above with reference to FIG. 1. Meanwhile, exemplary phosphors are as follow.

U.S. Pat. Nos. 5,998,925 and 6,069,440 describe a light-emitting device which emits white light through cerium (Ce)-activated garnet (yttrium aluminum garnet:cerium (YAG:Ce)) material containing one or more elements selected from the group consisting of Y, Lu, Sc, La, Gd, and Sm, and one or more elements selected from the group consisting of Al, Ga, and In. U.S. Pat. No. 6,504,179 describes a light-emitting device which emits white light through a Ce-activated garnet (terbium aluminum garnet:cerium (TAG:Ce)) material selected from the group consisting Tb, Y, Gd, Lu, and La.

U.S. Pat. No. 6,943,380 describes a light-emitting device which emits white light through an alkaline earth metal silicate (so-called silicate-based) material activated with europium (Eu).

FIG. 3 is a view of an example of a backlight display described in International Publication No. WO 2005/116972. This publication relates to the backlight display and a method of operation thereof. The backlight display includes a display backlight 221 having blue, red, green, and white LEDs 121, a diffuser 321 diffusing the optical sum of the light emitted from the backlight 221, a sensor 521 sensing the light emitted from the backlight 221, and a liquid crystal panel 421 providing an image to the front surface using the light emitted from the diffuser 321, wherein the light emitted from the backlight 221 is fed back to the sensor 521 and supplied to the liquid crystal panel 421 through the diffuser 321 with a controlled luminance. This backlight display has a disadvantage that the blue, red, green, and white LEDs 121 should be individually controlled to generate light and adjust its luminance.

FIG. 4 is a view of an example of a dimming circuit for an image display and a control method thereof described in Korean Patent 10-0767868. The dimming circuit includes a dimming control unit 231 controlling the power supply according to a dimming signal 131, an inverter 331 controlling power by the dimming control unit 231 and supplying the power to a backlight 431, and a liquid crystal panel 531 receiving light from the backlight 431 and providing an image, wherein dimming of the display is controlled through the dimming signal 131 and a feedback signal 631. The dimming of the display adjusts the brightness of the backlight 431 by controlling the current supplied to the backlight 431.

The present disclosure is intended to examine characteristics of fluorescent materials induced by changes in the current and to improve the problems which may subsequently occur.

### SUMMARY OF INVENTION

This section provides a general summary of the disclosure and is not a comprehensive disclosure of its full scope or all of its features.

For this purpose, the present disclosure provides a dimming control method for a display having a light-emitting device which includes a first light-emitting body including an active layer generating a first light by recombination of electrons and holes; and a second light-emitting body excited by the first light and emitting a second light having a longer wavelength than the first light, the dimming control method including controlling the power which will be supplied to the light-emitting device according to a dimming request; and adjusting the brightness of the display according to the controlled power using the second light-emitting body containing a first fluorescent material having a characteristic that chromaticity coordinates are shifted in a first direction according to the power control and a second fluorescent material having a characteristic that chromaticity coordinates are shifted in a second direction opposite to the first direction according to the power control.

Further areas of applicability will become apparent from the description provided herein.

### BRIEF DESCRIPTION OF DRAWINGS

The drawings described herein are for illustrative purposes only of selected embodiments and not all possible implementations, and are not intended to limit the scope of the present disclosure.

FIG. 1 is a view of an example of a conventional III-nitride semiconductor light-emitting chip.

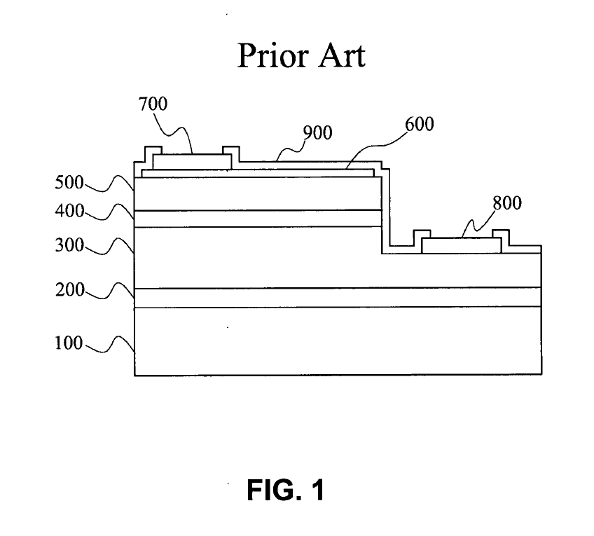

FIG. 2 is a view of an example of a semiconductor light-emitting device described in Korean Patent 10-0818518.

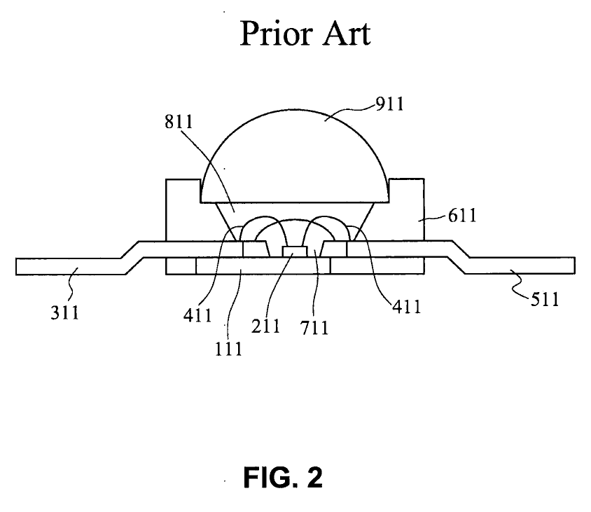

FIG. 3 is a view of an example of a backlight display described in International Publication No. WO 2005/116972.

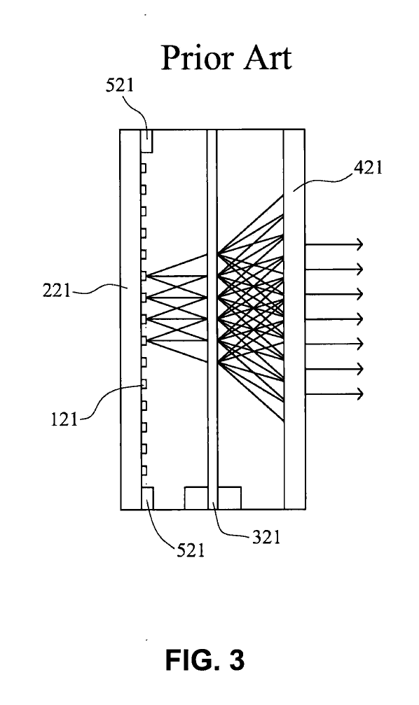

FIG. 4 is a view of an example of a dimming circuit for an image display and a control method thereof described in Korean Patent 10-0767868.

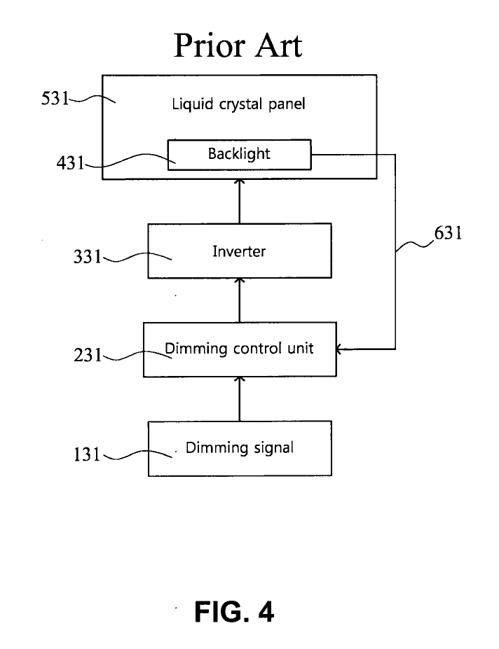

FIG. 5 is a view of a dimming control method for a display according to an embodiment of the present disclosure.

FIG. 6 is a view of an example of a light-emitting device provided in the dimming control method for the display according to the present disclosure.

FIG. 7 is a graph of an example of shifts of chromaticity coordinates of light caused by changes in the current in the light-emitting device provided in the dimming control method for the display according to the present disclosure.

FIG. 8 is a graph of an example of changes in the luminous flux caused by changes in the current in the light-emitting device provided in the dimming control method for the display according to the present disclosure.

FIG. 9 is a graph of wavelength distributions of the light emitted from the light-emitting device provided in the dimming control method for the display according to the present disclosure.

### DETAILED DESCRIPTION

The present disclosure will now be described in detail with reference to the accompanying drawings.

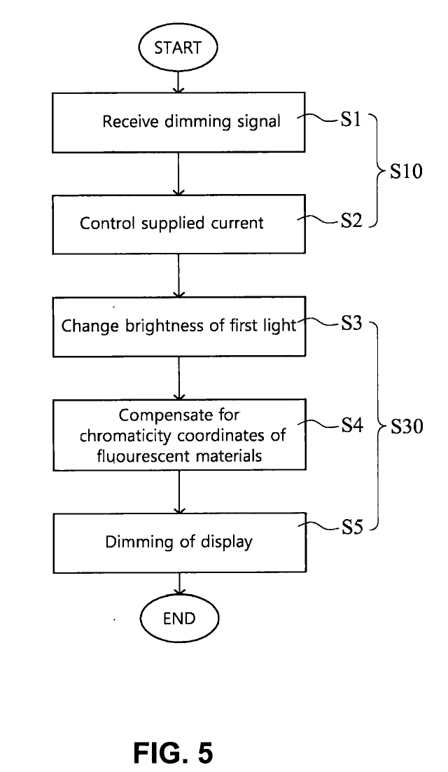

FIG. 5 is a view of a dimming control method for a display according to an embodiment of the present disclosure.

Referring to FIG. 5, in the dimming control method for the display according to the embodiment of the present disclosure, the power which will be supplied to a light-emitting device is controlled according to a dimming request (step S10), and then the brightness of the display is adjusted according to the power control (step S30). Hereinafter, the respective steps will be described in detail.

In order to control the power according to the dimming request (step S10), first a dimming signal is inputted (step S1). For example, the dimming signal may be generated in a panel driving unit driving the display, such as a liquid crystal panel, and then inputted to a dimming control unit. Thereafter, the power, e.g., the current which will be supplied to the light-emitting device is controlled by the dimming control unit according to the dimming signal (step S2). The control of the current includes increasing or decreasing the current. For example, the dimming control unit can control the power through an inverter using a pulse width modulation (PWM) control method.

Next, the brightness of the display is adjusted according to the controlled power (step S30). The present disclosure can adjust the brightness and hue of the light-emitting device for the dimming of the display, but prevent chromaticity coordinates of the light emitted from the light-emitting device from being unintentionally changed by the power control. For this purpose, a light-emitting device provided in the dimming control method for the display is used. Hereinafter, the light-emitting device provided in the dimming control method for the display according to the present disclosure will be described.

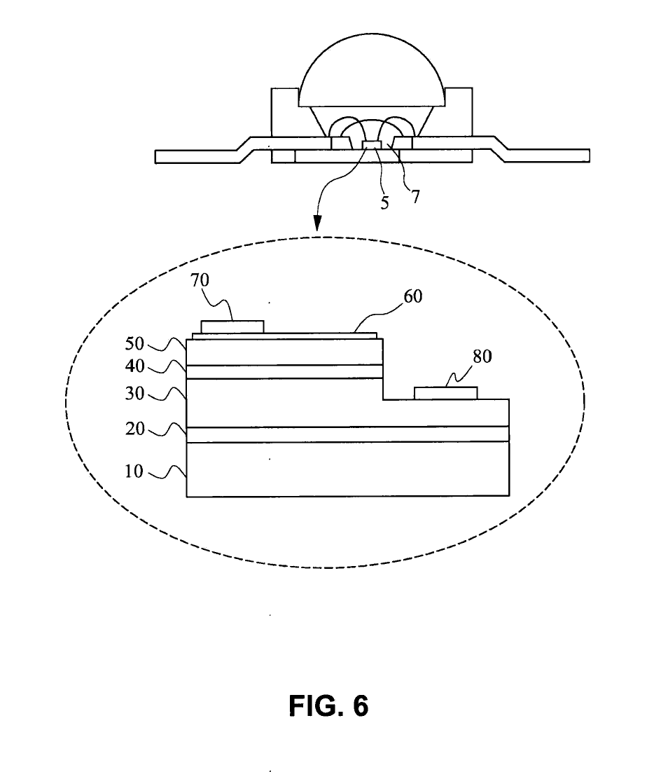

FIG. 6 is a view of an example of the light-emitting device provided in the dimming control method for the display according to the present disclosure. The light-emitting device includes a first light-emitting body 5 and a second light-emitting body 7.

The first light-emitting body 5 includes an active layer 40 generating a first light by recombination of electrons and holes. The first light-emitting body 5 may be a III-nitride semiconductor light-emitting chip. The III-nitride semiconductor light-emitting chip includes a substrate 10, a buffer layer 20 grown on the substrate 10, an n-type III-nitride semiconductor layer 30 grown on the buffer layer 20, the active layer 40 grown on the n-type III-nitride semiconductor layer 30 and generating the first light by recombination of electrons and holes, a p-type III-nitride semiconductor layer 50 grown on the active layer 40, a p-side electrode 60 formed on the p-type III-nitride semiconductor layer 50, a p-side bonding pad 70 formed on the p-side electrode 60, and an n-side electrode 80 formed on the n-type III-nitride semiconductor layer 30 exposed by mesa-etching the p-type III-nitride semiconductor layer 50 and the active layer 40.

The second light-emitting body 7 is made of a fluorescent material excited by the first light and emitting a second light having a longer wavelength than the first light. For example, the fluorescent material may contain a mixture of 3% of garnet-based fluorescent material and 6% of silicate-based fluorescent material.

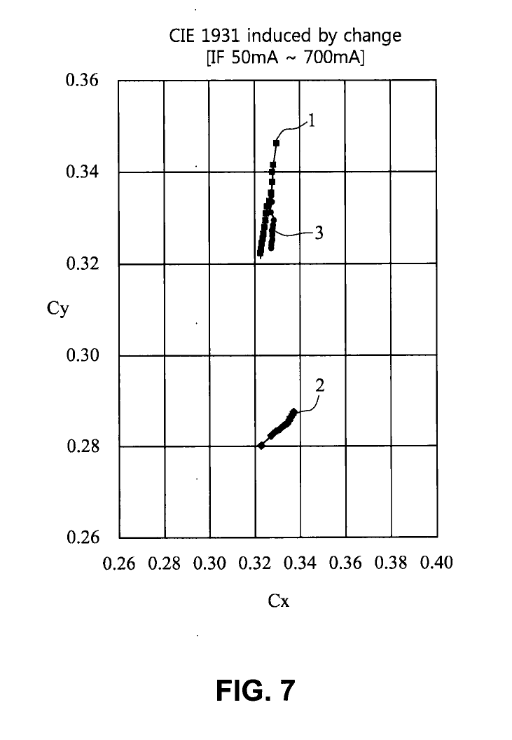

FIG. 7 is a graph of an example of shifts of chromaticity coordinates of light caused by changes in the current in the light-emitting device provided in the dimming control method for the display according to the present disclosure.

The first light-emitting body 5, which was the same as the light-emitting body described with reference to FIG. 6, was a III-nitride semiconductor light-emitting device emitting light of about 460 nm and having an output of about 218 mW.

In the graph, the axis of abscissas represents a Cx axis on the chromaticity coordinates (CIE-1931) and the axis of ordinates represents a Cy axis on the chromaticity coordinates. First points 1 represent shift characteristics of chromaticity coordinates of light of a light-emitting device using a garnet-based material (e.g., YAG 432) as a fluorescent material, and the chromaticity coordinates Cx and Cy induced by the changes in the current are as follows:

TABLE 1
Coordinates of first points

| | Current (mA) | | | | | | |
|---|---|---|---|---|---|---|---|
| | 50 | 100 | 150 | 200 | 250 | 300 | 350 |
| Cx1 | 0.3297 | 0.3289 | 0.3276 | 0.3273 | 0.3272 | 0.3262 | 0.3256 |
| Cy1 | 0.3461 | 0.3415 | 0.3385 | 0.3364 | 0.3344 | 0.3322 | 0.3308 |
| | Current (mA) | | | | | | |
| | 400 | 450 | 500 | 550 | 600 | 650 | 700 |
| Cx1 | 0.3254 | 0.3247 | 0.3241 | 0.3239 | 0.3235 | 0.3229 | 0.3226 |
| Cy1 | 0.3292 | 0.3277 | 0.3261 | 0.3254 | 0.3243 | 0.3230 | 0.3223 |

Referring to Table 1, as the current increased from 50 mA to 700 mA, Cx1 of the first point 1 was shifted from 0.3297 to 0.3226 (i.e., shifted to the left side) and Cy1 of the first point 1 was shifted from 0.3461 to 0.3223 (i.e., shifted to the downside).

Second points 2 represent shift characteristics of chromaticity coordinates of light of a light-emitting device using a silicate-based material (e.g., silicate FA573) as a fluorescent material, and the chromaticity coordinates Cx and Cy induced by the changes in the current are as follows:

TABLE 2
Coordinates of second points

| | Current (mA) | | | | | | |
|---|---|---|---|---|---|---|---|
| | 50 | 100 | 150 | 200 | 250 | 300 | 350 |
| Cx2 | 0.3230 | 0.3273 | 0.3287 | 0.3305 | 0.3316 | 0.3325 | 0.3330 |
| Cy2 | 0.2801 | 0.2823 | 0.2828 | 0.2836 | 0.2837 | 0.2843 | 0.2841 |
| | Current (mA) | | | | | | |
| | 400 | 450 | 500 | 550 | 600 | 650 | 700 |
| Cx2 | 0.3341 | 0.3348 | 0.3355 | 0.3359 | 0.3365 | 0.3344 | 0.3369 |
| Cy2 | 0.2850 | 0.2853 | 0.2860 | 0.2862 | 0.2865 | 0.2848 | 0.2873 |

Referring to Table 2, as the current increased from 50 mA to 700 mA, Cx2 of the second point 2 was shifted from 0.3230 to 0.3369 (i.e., shifted to the right side) and Cy2 of the second point 2 was shifted from 0.2801 to 0.2873 (i.e., shifted to the upside).

That is, in the above Tables 1 and 2, it can be seen that the chromaticity coordinates of the light emitted from the light-emitting device are shifted due to the changes in the current.

Third points 3 represent shift characteristics of chromaticity coordinates of light of a light-emitting device using a mixture of a garnet-based material and a silicate-based material as a fluorescent material, and the chromaticity coordinates Cx and Cy induced by the changes in the current are as follows.

TABLE 3
Coordinates of third points

| | Current (mA) | | | | | | |
|---|---|---|---|---|---|---|---|
| | 50 | 100 | 150 | 200 | 250 | 300 | 350 |
| Cx3 | 0.3273 | 0.3278 | 0.3271 | 0.3284 | 0.3281 | 0.3282 | 0.3278 |
| Cy3 | 0.3348 | 0.3334 | 0.3310 | 0.3294 | 0.3285 | 0.3278 | 0.3268 |
| | Current (mA) | | | | | | |
| | 400 | 450 | 500 | 550 | 600 | 650 | 700 |
| Cx3 | 0.3278 | 0.3279 | 0.3282 | 0.3275 | 0.3278 | 0.3276 | 0.3274 |
| Cy3 | 0.3263 | 0.3256 | 0.3252 | 0.3245 | 0.3246 | 0.3239 | 0.3233 |

Referring to Table 3, as the current increased from 50 mA to 700 mA, Cx3 of the third point 3 was shifted from 0.3273 to 0.3274 (i.e., seldom shifted) and Cy3 of the third point 3 was shifted from 0.3348 to 0.3233 (i.e., shifted to the downside).

TABLE 4
Comparison of coordinates shifts of first points, second points,
and third points

| | | | Garnet + | Shift improvement |
|---|---|---|---|---|
| | Garnet-based | Silicate-based | Silicate-based | rate |
| Cx | 0.00222 | 0.00396 | 0.00037 | −83% |
| Cy | 0.00728 | 0.00189 | 0.00355 | −51% |

When light emitted from the light-emitting device using the mixture of the garnet-based material and the silicate-based material according to the change in the current is compared with the light emitted from the light-emitting device using the garnet-based material or the silicate-based material according to the change in the current, the shift of Cx is improved by about 83% and the shift of Cy is improved by about 51%.

The improvement in the shift of the chromaticity coordinates means the improvement in changes in the wavelength of the light emitted from the light-emitting device upon the change in the current for the dimming of the display, which means the improvement in changes in light's color. In other words, the present disclosure is advantageous in that it can improve changes in the color sense of the display upon the dimming of the display.

In the above example, the combination of the phosphors was performed setting changes in the Cx values as a target. Since the change directions of the Cy values of the first points 1 and the second points 2 are opposite to each other, the combination of the phosphors may be controlled setting changes in the Cy values as a target. Two or more phosphors can be selected and combined considering the target and the other elements.

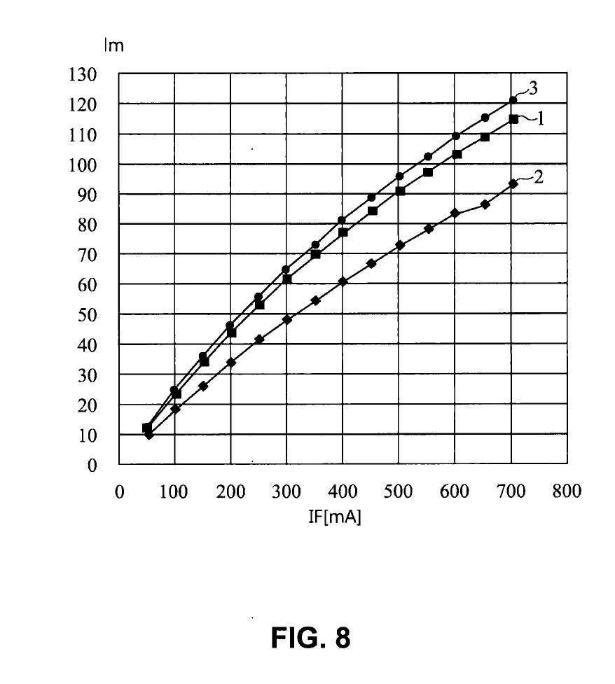

FIG. 8 is a graph of an example of changes in the luminous flux caused by changes in the current in the light-emitting device provided in the dimming control method for the display according to the present disclosure. First points 1 represent the luminous flux of a light-emitting device having a garnet-based fluorescent material by the changes in the current, second points 2 represent the luminous flux of a light-emitting device having a silicate-based fluorescent material by the changes in the current, and third points 3 represent the luminous flux of a light-emitting device having a mixture of a garnet-based fluorescent material and a silicate-based fluorescent material by the changes in the current. The luminous flux of the third points 3 has been more improved than those of the first points 1 and the second points 2 according to the changes in the current.

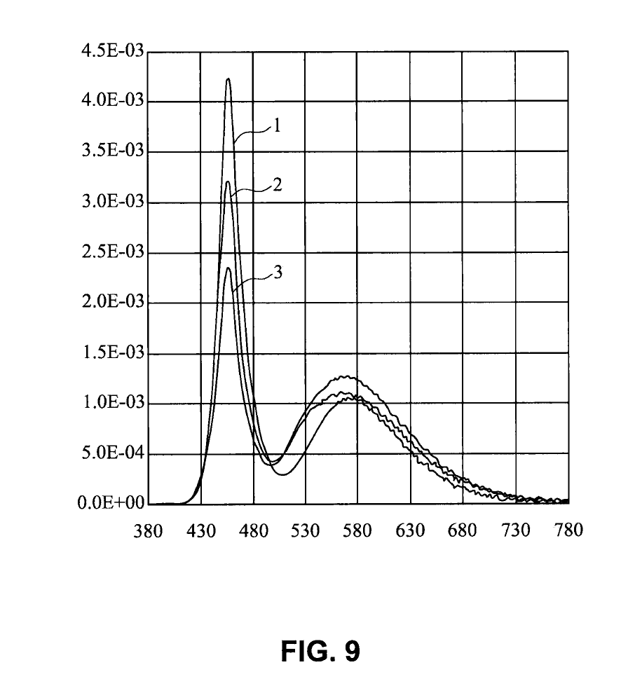

FIG. 9 is a graph of wavelength distributions of the light emitted from the light-emitting device provided in the dimming control method for the display according to the present disclosure. A first graph 1 is a graph of the wavelength distribution of the light emitted from a light-emitting device having a garnet-based fluorescent material, a second graph 2 is a graph of the wavelength distribution of the light emitted from a light-emitting device having a silicate-based fluorescent material, and a third graph 3 is a graph of the wavelength distribution of the light emitted from a light-emitting device having a mixture of a garnet-based fluorescent material and a silicate-based fluorescent material. Color rendering of the third graph 3 is more improved than those of the first graph 1 and the second graph 2.

The shift of chromaticity coordinates of the light which forms the basis of the display is prevented using the light-emitting device provided in the dimming control method for the display according to the present disclosure as described with reference to FIGS. 6 to 9.

For example, a quantity of the first light of the first light-emitting body 5 is changed according to the increase or decrease of the current, and thus the brightness of the first light is changed (step S3).

Next, shifts of chromaticity coordinates of a first fluorescent material and a second fluorescent material, which have been caused by the change in the brightness of the first light, are compensated (step S4). The second light-emitting body 7 is excited by the first light, and thus emits the second light in which the shift of the chromaticity coordinates has been compensated, i.e., suppressed. For example, according to the increase or decrease of the current (i.e., the increase or decrease of the brightness of the first light), as described with reference to FIG. 7, the chromaticity coordinates of the light emitted from the first fluorescent material, e.g., the garnet-based fluorescent material excited by the first light are shifted in a first direction. The chromaticity coordinates of the light emitted from the second fluorescent material, e.g., the silicate-based fluorescent material excited by the first light are shifted in a second direction almost opposite to the first direction. Therefore, the chromaticity coordinates of the second light generated by combining the light emitted from the first fluorescent material and the light emitted from the second fluorescent material are substantially little changed in the first and second directions. As set forth herein, the shifts of the chromaticity coordinates of the first fluorescent material and the second fluorescent material may be opposite to each other in the Cx-axis direction, the Cy-axis direction, or both Cx and Cy-axis directions on the chromaticity coordinates.

Next, the dimming of the display is performed (step S5). The light emitted from the light-emitting device may form the basis of the display. For example, the light emitted from the light-emitting device is supplied to the liquid crystal panel through an optical member such as a diffuser. The liquid crystal panel performs the display based on a display signal transferred from the panel driving unit and the light emitted from the light-emitting device. Although the brightness of the light emitted from the light-emitting device is adjusted for the dimming, the unintended shift of the chromaticity coordinates of the light is substantially prevented as described above. Accordingly, the dimming quality of the display is improved. Hereinafter, various modes of the present disclosure will be described.

A dimming control method for a display having fluorescent materials with different shift direction characteristics of chromaticity coordinates.

A dimming control method for a display having different fluorescent materials in which shift direction characteristics of chromaticity coordinates are compensated.

A dimming control method for a display having a mixture of a garnet-based fluorescent material and a silicate-based fluorescent material.

A dimming control method for a display which compensates for a shift of a phosphor on chromaticity coordinates caused by a change in the current.

According to a dimming control method for a display of the present disclosure, the problem that chromaticity coordinates of the light emitted from a phosphor are unintentionally shifted by changes in the current can be improved.

According to another dimming control method for a display of the present disclosure, changes in the color sense can be improved.

According to a further dimming control method for a display of the present disclosure, the dimming control can be simplified.

It will be apparent to those skilled in the art that modifications and variations can be made in the present disclosure without deviating from the spirit or scope of the disclosure. Thus, it is intended that the present disclosure cover any such modifications and variations of this disclosure provided they come within the scope of the appended claims and their equivalents. Accordingly, these and other changes and modifications are seen to be within the true spirit and scope of the disclosure as defined by the appended claims.

In the specification, there have been disclosed typical embodiments of the disclosure and, although specific terms are employed, they are used in a generic and descriptive sense only and not for purposes of limitation. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention. The terminology used herein is for the purpose of describing particular example embodiments only and is not intended to be limiting.

As used herein, the singular “a”, “an” and “the” may be intended to include the plural forms as well, unless the context clearly indicates otherwise. The terms “comprises”, “comprising”, “including”, and “having” are inclusive and, therefore, specify the presence of stated features, integers, steps, operations, elements, and/or components, but do not preclude the presence or addition of one or more other feathers, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

What is claimed:

1. A dimming control method for a display having a light-emitting device which comprises: a first light-emitting body including an active layer generating a first light by recombination of electrons and holes; and a second light-emitting body excited by the first light and emitting a second light having a longer wavelength than the first light,
the dimming control method comprising:
controlling the power which will be supplied to the light-emitting device according to a dimming request; and
adjusting the brightness of the display according to the controlled power using the second light-emitting body containing a first fluorescent material having a characteristic that chromaticity coordinates are shifted in a first direction according to the power control and a second fluorescent material having a characteristic that chromaticity coordinates are shifted in a second direction opposite to the first direction according to the power control.

2. The dimming control method of claim 1, wherein the adjusting the brightness of the display according to the controlled power comprises:
changing a quantity of the first light by the power control; and
combining the light emitted from the first fluorescent material excited by the first light with the light emitted from the second fluorescent material and compensating for the change in the chromaticity coordinates of the second light.

3. The dimming control method of claim 1, wherein the chromaticity coordinates of the light emitted from the first fluorescent material and the chromaticity coordinates of the light emitted from the second fluorescent material are shifted in opposite directions with respect to the Cx axis of the chromaticity coordinates according to the power control.

4. The dimming control method of claim 1, wherein the chromaticity coordinates of the light emitted from the first fluorescent material and the chromaticity coordinates of the light emitted from the second fluorescent material are shifted in opposite directions with respect to the Cy axis of the chromaticity coordinates according to the power control.

5. The dimming control method of claim 1, wherein the first fluorescent material is a garnet-based fluorescent material.

6. The dimming control method of claim 1, wherein the second fluorescent material is a silicate-based fluorescent material.

7. The dimming control method of claim 1, wherein the first light-emitting body is a III-nitride semiconductor light-emitting chip.

8. The dimming control method of claim 1, wherein the power control is to control the current supplied to the light-emitting device.

9. The dimming control method of claim 1, wherein the first direction and the second direction are opposite to each other on the Cx axis of the chromaticity coordinates, the first fluorescent material is a garnet-based fluorescent material, and the second fluorescent material is a silicate-based fluorescent material.

10. The dimming control method of claim 1, wherein the first direction and the second direction are opposite to each other on the Cy axis of the chromaticity coordinates, the first fluorescent material is a garnet-based fluorescent material, and the second fluorescent material is a silicate-based fluorescent material.
